(19) United States
(12) Patent Application Publication
(10) Pub. No.: US 2008/0147671 A1
(43) Pub. Date: Jun. 19, 2008

(54) System for Running Web Applications Offline and Providing Access to Native Services

(75) Inventors: Gregory Simon, San Francisco, CA (US); Manjirnath Chatterjee, San Francisco, CA (US)

Correspondence Address: KACVINSKY LLC;C/O INTELLEVATE, P.O. BOX 52050, MINNEAPOLIS, MN, 55402, US

(73) Assignee: LAMPDESK CORPORATION, San Francisco, CA (US)

(21) Appl. No.: 11/612,282

(22) Filed: Dec. 18, 2006

(51) Int. Cl. G06F 17/30

(52) U.S. Cl. 707/10; 707/E17.001

(57) ABSTRACT

Web applications such as email, photo-sharing website, or web widgets work only when the offsite server is available to provide content in real-time. The present invention provides a generic web standards based method of encapsulating the offline web application along with its runtime environment so that web applications can run even when connection to the server is not available. In addition the present invention combines methods for creating, provision, and running multiple offline web applications on a desktop computer or a mobile device such as cellular telephone or personal digital assistant. In addition the present invention also provides the ability to synchronize user data so that multiple devices can be provisioned for offline use with the same set of personalized user information.

### BACKGROUND OF THE INVENTION

1. Field of the Invention

The present invention is a system for running and authoring internet and web applications with standardized technologies such as HTML, CSS, and a scripting language such as JavaScript offline and when a server is not available. The present invention provides details on how to deploy and manage such applications and how to manage interfaces to access local native services of the device for which there are no web language interfaces as web languages such as HTML, JavaScript, and the like run in a browser sandbox and only have programmatic interfaces to manipulate data on the server from which they are hosted.

2. Prior Art

U.S. Pat. No. 6,996,537—“System and method for providing subscribed applications on wireless devices over a wireless network”—Minear, et. al. [Qualcomm]—Describes the management of subscriptions on wireless devices but does not provide for a means for web technology based applications to run locally and does not mention how such applications which are composed of multipart file bundles can be deployed as an atomic unit and signed as an atomic unit. This patent also does not delineate how to create a connection between a local engine which contains the application and a browser for click-through connections to the world wide web in real time.

U.S. Pat. No. 6,832,253—“Viewing web pages on small screen devices using a keypad for navigation, Itavaara et. al.” [Nokia]—Describes segmenting a screen in to small units each which can be divided but does not describe how an entire web application can get stored and managed on a device. It also does not provide for an idea of page “flipping” in which local applications can serve pages quickly.

U.S. Pat. No. 6,779,042—“System, method, and computer program product for enabling on-device servers, offline forms, and dynamic ad tracking on mobile devices”, Kloba et. al. [iAnywhere]—Shows a method for caching web based content and reserving on a mobile device, even in an offline state. It also describes the reformatting or preparation of the look and feel of the content (optimization) so that it is presented in a more optimal manner. However this art does not describe how to package such information such that an entire application is synchronized so that it runs locally—rather this art describes a complex method of data caching. Also the present information separates content, including user data, as completely separate from the application code which renders the data and these items, in the present invention are treated so that the user's content and personal data can be updated without the need for updating the application itself. This allows the present invention to save bandwidth, increase responsiveness, and through an applied security model, allows the present invention to mix content from multiple servers from an application running on the local device whereas Kloba et. al does not.

U.S. Pat. No. 6,553,412—“System, method, and computer program product for web content aggregation and development, and web content delivery to clients”, Kloba et. al. [AvantGo]—This prior art describes a system of channels in which various items can be deposited and cached. However it does not delineate how to store entire bundles as single atomic units nor does it provide for a method such that web based programming methodologies such as HTML and JavaScript can be used to access native services of the device which are outside of this system. In the present invention collections of assets are made in to atomic bundles of files which can be signed and in addition the present invention allows for the use of native services, such as local operating system calls or local peripherals (such as device mounted cameras) to be used.

U.S. Pat. No. 6,421,717—“System, method, and computer program product for customizing channels, content, and data for mobile devices”, Kloba et. al. [AvantGo]—This art describes a method of serving content on regular intervals such as refreshing news stories via RSS feeds as is done with other programs on both desktop computers and mobile devices today. While the dynamic refreshing of content via polling methods is useful it does not embody client side functionality in a way in which locally running executables can access multiple sites, maintain security, or partially cache local icons and combine them with the newly acquired information to create a low bandwidth high user experience effect. The present invention not only allows for local programs written with web languages to get content but also runs a proxy, as known to those skilled in the art, to allow for secure mash-ups of information to only those apps which are securely signed or authorized.

Apple Computer makes a widget like programming environment colloquially known as Dashboard. This environment serves up mini applications called widgets using web technologies such as HTML, JavaScript, and CSS and is based on the webkit technology base. However it does not run as a server on client methodology as the present invention but instead runs effectively as a modified internet browser framework with extensions to access the host operating system through a modified HTML DOM API as known to those skilled in the art. This allows for high performance rendering in a graphical sense but does not allow for the provisioning of application bundles, subscriptions to applications, or extensible services framework in which other clients can surf to an application or have it served over a network as with the present invention. Also there is no way for plugin native services to extend the Dashboard framework, as with the present invention, except by hand modifying the source code to the underlying HTML DOM or javaScript functions. In addition the use of special functions for high performance graphics and rendering precludes its use on mobile devices such as with the present invention. Finally, the Dashboard environment does not provide automatic means for synchronizing and backing up of user data.

Another example of a small mini application is the commercial environment known as Konfabulator which is now part of the Yahoo! widget engine. This environment is based on creating small mini-applications which use a proprietary language and runtime environment to create a similar effect as what can be created using web standards. This environment allows the creation of visually mini-applications however its use of a proprietary authoring technique limits its portability across desktop operating system. Many individual widget applications must be adapted to the host operating system negating the effectiveness of the paradigm. In addition the heavy weight nature of the rendering layer which is part of the environment precludes its use on mobile devices.

Another method of provision mobile devices is via the use of the Java 2 Micro Edition (J2ME also called JME) programming environment. This environment takes programs written in the Sun Microsystems Java programming language and runs them on special virtual machine which has been created for limited CPU and limited memory environments. Since all Java programs run in a special sandbox (the Java Virtual Machine heap) access to native functionality is only available through special application programming interfaces known as JSRs (Java Specification Requests) which are agreed upon by the larger Java development community. Java programs running on the JVM do not have innate web browser like communications or rendering capabilities—the use of the network is restricted by the JVM and the only way to render web content such as HTML is through hand coding a software based renderer in the Java language itself. This restriction can somewhat be overcome by using a link to launch the on device web browser. However this causes the device to undergo a large software context switch which is not permitted under many implementations of J2ME. For those where this context switch is permitted, a large delay is induced while the browser is launched and then connectivity is established. This is greatly exacerbated by the fact if connectivity to the requested resource is not available to the browser the user is often subjected to a lengthy click—launch browser—wait for connection—delay cycle in which the end result is essentially a blank screen. Even on devices with relatively high end CPUs the best case cycle is many tens of seconds which causes users to be frustrated and update of Java to browser based click through services to be slow. The present invention leverages the local web browser as a rendering engine and hence has no such delay. In addition the present invention allows programs to run unmodified on desktop computer environments whereas the Java Mobile Environment is not supported on desktop computers—instead a different rendering architecture called the Java Standard edition classes must be used greatly limiting application portability across environments.

To overcome many of the performance deficits of the J2ME environment Qualcomm Corporation introduced a different programming paradigm to the mobile marketplace with emphasis on speed and deployment. This environment is branded BREW which stands for Binary Runtime Environment for Wireless. The BREW system is a C based programming environment which runs code directly on the microprocessor rather than on a Virtual Machine such as in Java. This results in higher performance. Also the BREW environment integrates the billing and deployment logic necessary for a wireless carrier to push an application to a mobile device and to arrange either a subscription based or one time fee based payment for the use of the application. However BREW does not offer automatic rendering and handling of web content and hence, like J2ME, the use of web content requires the either the launching of the web browser or the handcrafting, by the developer, of the necessary code to render web content such as HTML inside the BREW environment. Like Java the launching of the device native browser can create long delays as the user waits for the browser and associated connectivity to launch and then additional delays as the browser attempts to make a data connection over the wireless air interface. Also, unlike the present invention. BREW does not provide an automated method for user data to be provisioned over a network and also does not provide for compatibility with desktop computer environments.

### OBJECTS AND ADVANTAGES

The present invention has several advantages over existing prior art. Several of these are performance oriented in nature or reflect decreased development time for programmers whereas the second set of advantages represent new and compelling functionality which seamlessly tie mobile device and desktop experiences in a more compelling manner than previously available. In addition the present invention allows the use of web programming paradigms, such as JavaScript, HTML, CSS, and XML to write standalone applications on a mobile device or desktop computer, greatly speeding up the programming time required to create a visual content based application.

The present invention also allows the use of server side programming techniques to be combined with these client side web technologies through the use of SOAP services, XML RPC services and the like to access a database. The present invention also leverage the ability to run server side code such as PHP, Python, PERL or CGI programming environments locally, on the client computer, as part of the deployed application environment. This allows the local use of sessions and other programming paradigms all running on a client which lessons the computational load on the server and enables web based applications to run even when a main server on the internet or intranet is not available.

Another set of key advantages of the present invention is the conservation of bandwidth which is especially important for mobile device deployments. This is accomplished since many of the graphical assets of an application, such as the background images, often take more than ninety percent of the memory of application storage footprint. However the present invention allows application resources, such as background images and icons, to be stored on the client rather than being loaded over an internet connection each time the application is used. For applications running on wireless devices, this can also translate in to tremendously reduced application latency as since the resources of the application are stored locally there is no delay fetching the data over the air. For battery powered devices this has the added advantage of greatly reducing the amount of power consumption required since the radio need not be used thereby increasing battery life.

The present invention also allows the use of local services which normally would be accessed via a compiled language such as C or C++. Web languages, such as JavaScript or ECMAScript run in a sandbox and have no ability to access local resources directly. This is done for security purposes. However with the present invention local services can be brokered through SOAP, XML remote procedure calls or other means to access the local file system, database, or even device specific proprietary interfaces such as a camera in the case of a wireless phone. Since the present invention emulates an entire server software stack it enables usual web based security models and access restrictions to be enforced as is known in the art.

The present invention also allows different web applications to simultaneously have different security levels. This is further enhanced by the ability to sign web apps via the manifest mechanism noted in the description of the invention section which can then be verified by a 3rd party authentication service.

The present invention allows for truly portable code in a write once run anywhere fashion as the graphical layout and programming support are available on both mobile devices and all modern desktop computer operating systems. This is not true for Java where the graphical framework is different for server, desktop, and mobile environments. This is also not true BREW environments as this technology has no desktop equivalent. While programmer's tools such as simulators for development may run some aspects of BREW or mobile Java applications on desktops they are not available for end user's to run BREW or J2ME applications on any desktop computer.

### LIST OF FIGURES

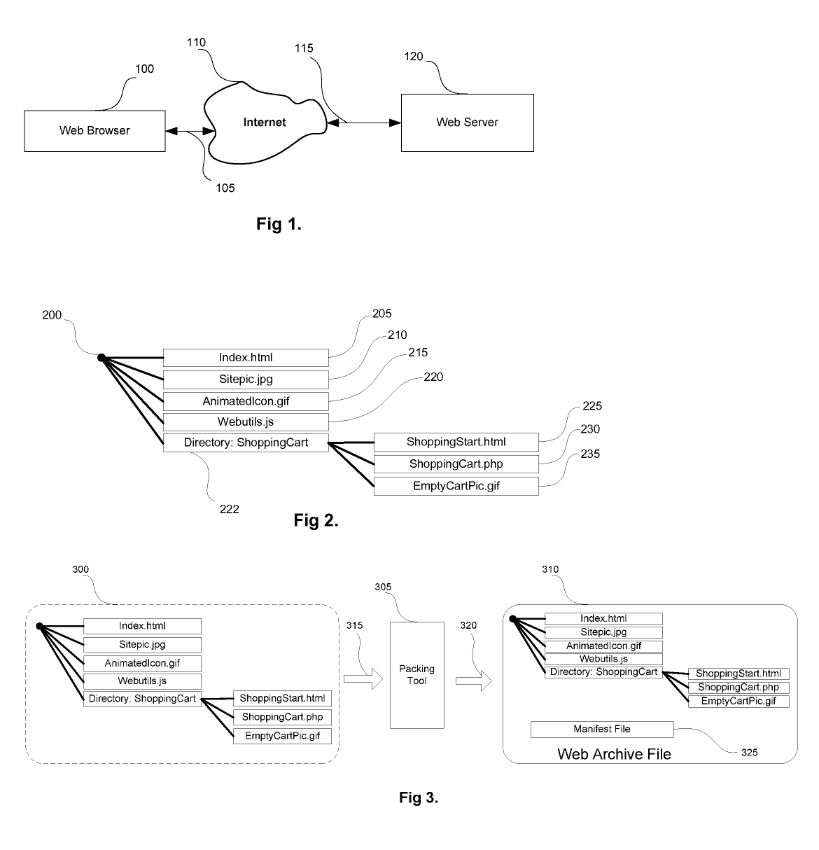

(1) FIG. 1. Represents a classic (such as Apache) http client and server connected via the Internet.

(2) FIG. 2. Depicts the layout of assets of typical web based applications as run on a server farm at a large company website

(3) FIG. 3. Shows the Web bundle packing process which outputs web archive file+manifest as is part of the present invention

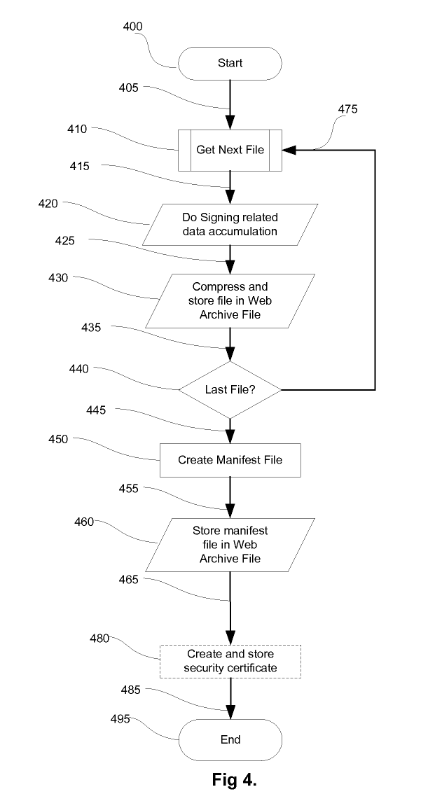

(4) FIG. 4. Shows the details of the Web archive packing process

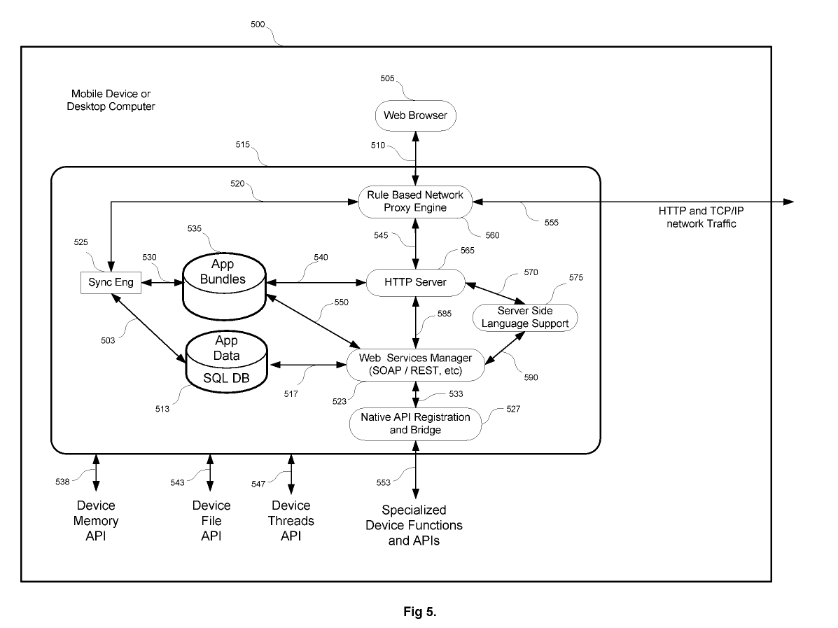

(5) FIG. 5. Depicts the assets of the present invention—the Web Virtual Machine.

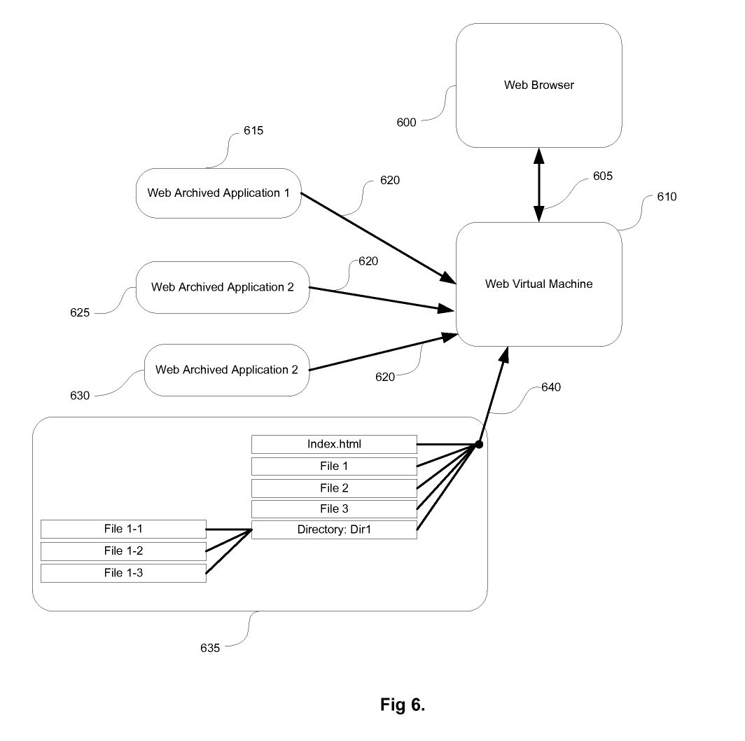

(6) FIG. 6. Shows how the present invention can server multiple web applications simultaneously

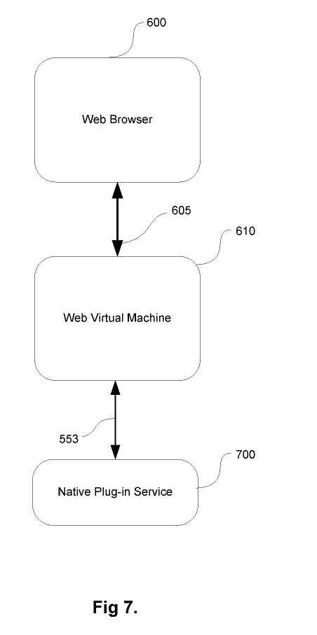

(7) FIG. 7. Depicts the bridge from a Web Applications to a native API

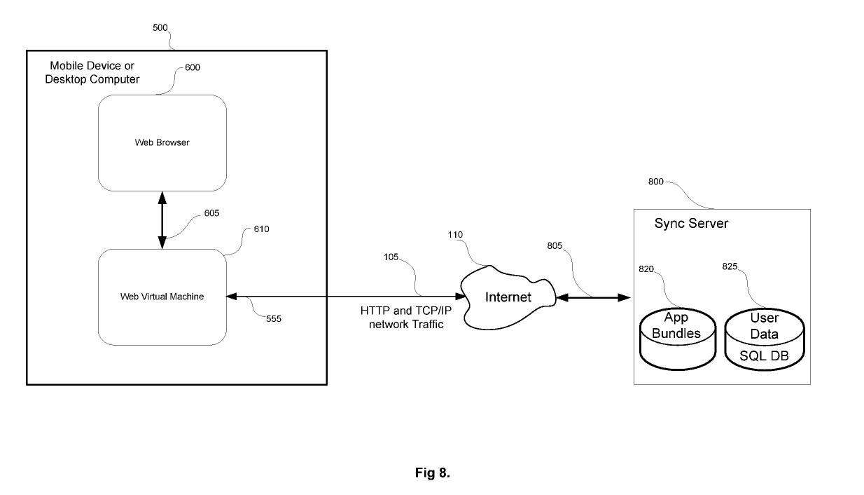

(8) FIG. 8. Depicts shows how a sandboxed browser application can access a native device service through the present invention.

### DESCRIPTION OF THE INVENTION

The present invention builds upon the basic http client server model of HTTP connections to leverage a new user experience and web application programmer model by consolidating traditional client server mode programming into a new client based programming model with extra enhancements for offline application access.

FIG. 1. Represents a classic (such as Apache) http client and server connected via the Internet. A web browser (100) is connected via path 105 to the Internet (block 110) via path 115 to a web server (120. Here the paths 105 and 115 represent HTTP protocol paths over layered on top of the TCP/IP protocol as is known in the art.

FIG. 2. Depicts the layout of assets of typical web based applications as run on a server farm at a large company website. When creating a website various files are used to represent the content which would then be served to the internet as is depicted by block 120 in FIG. 1. In FIG. 2 we see the application assets used by the web server. Node 200 in FIG. 2 represents the root of the directory where the application is stored. In this directory we also see a file (205) called index.html. When the browser, such as 100 in FIG. 1, sends a request to the URL of a website (such as www.lampdesk.com/filename) the web server looks in the declared root directory (200) of its home file system and searches for the requested file else it returns an error code. If the URL contains only a directly location such as (www.lampdesk.com) then the web server looks for index.html as the default page to return to the requesting browser. Note that some web servers also use plug-in languages to redirect index.html to other local assets for example the index.html file could instruct the webserver to launch a server side program such as a login script which would ask the user to login to the web server to access privileged content. FIG. 2 items 210, 215, and 220 represent other items in the root directory. It is possible that the browser, once loading index.html will see links to these other items which in this case are graphics and JavaScript file to add interactivity. Item 222 is a directory which contains more assets of the website and application resources. Items 225, 230, 235 represent server side assets that can be invoked through a direct path request for example (www.example.com/ShoppingCart/ShoppingStart.html), perhaps in response to following a hyperlink on the original web page. Often the server will restrict access to such directories unless the user has logged in first. Note that a web application is a web site consisting of multiple files spread throughout a directory structure. There is no standard way to “pack” such an application and move it to another server or even to speed application latency by storing, in a structured way, portions of the application on the client. However a web browser may cache some of the assets on its own, but it does this without knowing what is really on the server so if the server is dynamically generating content seen by a browser it will render old content or be missing some the processing logic which controls the content from the server side.

FIGS. 1 and 2 depict how websites and web applications are deployed on the Internet today. Not pictured is that often some of the script files (perhaps the ShoppingCart.php shown in FIG. 2) invoke server side programs to store user data in a database on the server. This allows large web servers to run web applications which can broker between databases and the user's web browser.

The next set of figures depicts the present invention in logical form. The present invention takes several components of the web server and compacts and expands upon them so that the entire web server and support assets can run locally on the same computer as the browser is running. In fact some implementations of the present invention are small enough that they can be run on desktop personal computers or mid price range mobile phones. Advantages of this server-on-client approach are many, but include some of the following: multiple web apps running on the same machine, low latency as content is local, access to local device services such as camera media stores or phonebooks, and ease of authoring as now the same paradigm used to author large web sites can be used to author portable client side applications. The present invention further expands on this by adding an optional synchronization engine which can sync either application assets or user data stored in a local database back to a parent server on the internet.

Since web applications are written as several files spread over a directory structure it is difficult to deploy them on to a client computer or to even move them from one server to another. FIG. 3. Shows the Web bundle packing process which outputs web archive file+manifest as is part of the present invention. Box 300 represents an entire web application directory tree and can be thought of as all the components in FIG. 2. Logically we then transform via 315, a special software tool 305, and 320, the entire directory tree in to a compressed archive 310 which contains all of the files and pathnames of the assets in 300 plus a new file called the manifest file in 325. Box 305 represents a tool which compresses each file preserving its name and relative directory structure so that what was an entire directory tree of files and subdirectories becomes a single archive. This is called the web archive file. The packing, storage, and compression can be accomplished using standard file archiving libraries such as zip, gzip or zlib as is known in the art or by using a proprietary packing scheme. The manifest file 325, contains metadata which may include but is not constrained to, application name information, checksum information (including for each file in the archive or for the whole archive), digital signature information about the application, and information about the application's runtime needs and APIs required. The manifest file may be implemented as name-value pairs, as an XML format, or any other format which can contain readable metadata as is known by those skilled in the art. The packing process employed by tool 305 is shown in more detail in FIG. 4. Note that the Packing Tool runs offline from the present invention but is a tool which provides application packing and verification for the present invention's use.

FIG. 4. Shows the details of the Web archive packing process. Starting with 400, the start box and passing through 405 to box 410 the packing tools extracts the next file in the directory in a recursive search. Note that the recursive search also searches sub directories after it finishes with files in the current directory. Then following path 415 to 420 we optionally accumulate data about the file for possible signing purposes. This step can use the file to understand what APIs the file uses which an be useful for building a capability list of overall APIs used by the application. From 425 we go to 420 where the file is compressed and added to the web archive file. Following 435 to 440 the packing tool checks is this is the last file in the directory structure of the web application. If this is not the last file then path 475 is followed to 410 to repeat the process. If this is the last file path 445 is followed to 450 where the manifest file is updated. Then path 465 is followed to 460 where the manifest file is updated and stored in to the archive with the other files. Then path 465 is followed to box 480 which is an optional step to create and store a security certificate in to the archive. Then path 485 is followed to box 490 to end the process. Note it is possible for the security certificate to be amended to the manifest file in which case a separate security certificate file is not required.

FIG. 5. Depicts a typical implementation of the present invention—the Web Virtual Machine—as configured to run on either a mobile device such as a mobile telephone or a desktop computer. 500 depicts a mobile device or desktop computer in which the current invention is implemented and running. 505 is a web browser which is used as the user interface display engine. The browser takes user interface input in the forms of key presses, mouse events, touch screen events, touch pad events, button clicks and the like. The browser also displays XHTML/HTML content and supports dynamic scripting languages such JavaScript or other dynamic user interface description languages as are known in the art. Several of these are standardized by bodies such as the World Wide Web consortium (also known as the W3C) and include but are not limited to HTML, XHTML, JavaScript, ECMAScript, VBScript, VRML, SVG, CSS, CSS2, XML and WML. Other standards bodies for which the browser may render compliant content are the Open Mobile Alliance (OMA), while other content types readily renderable with internet browsers include Macromedia (now Adobe) SWF (more commonly known as Flash) format. The box labeled 515 represents the actual implementation of the present invention. For descriptive purposes this shall be referred to as the Web Virtual Machine or WebVM in this writing as it encapsulates many well known attributes of typical server side setups (such as those shown in box 120 in FIG. 1, and also several extra features which are new and bear out extra usefulness and novelty. The WebVM interacts directly with the browser via connection 510 which is an http network connection which runs on device. Typically this can be invoked by the browser connecting to the local host IP address of 127.0.0.1 but this need not be fixed and in fact the present invention may serve content to the browser on any of several addresses or address and port combinations. This also allows different applications to be served by the present invention simultaneously (on the different address port combinations) and at different security levels and with each application having different permissions levels and access rights to local resources. The WebVM connects to device services through interfaces 538 (Device Memory API), 543 (Device File API), 547 (Device Threads API), and 553 (Specialized Device Functions and APIs). Note that WebVM uses 538, 543, and 547 to connect resources that facilitate internal operation such memory access, file system, and task/threading and are also use for porting of the present invention among different classes of devices and operating systems. Interface 553 is a meta-interface which represents the expandable nature of the present invention. Using SOAP, REST, or other web services bindings as is known in the art, web programs running either in the present invention, the WebVM, or via the browser, such as through an AJAX call, can access special services to the Mobile Device. For example on many mobile phones or personal digital assistants there exist a phonebook or a digital media store from an on device camera which is available as a C++ or Java service. By using the present invention's interfacing capabilities through the interface 553 it is possible to let web applications run locally (on the mobile device or desktop computer) and yet not have outside server dependencies and be able to access local services and yet maintain a client-server programming model based on web programming techniques and with web security models intact. For example web based phone book application could access the local phonebook on a mobile phone via the interface 553 and then store associations locally in 513 (more details shall be discussed shortly) to create hybrid functionality and then later this same web application can send or store the phonebook information so retrieved via interface 555 to an online web portal on the internet.

In normal operation the present invention operates several portions of an http server stack. These can be seen by the interaction of the browser through path 510 to box 560 which is a network proxy software stack which redirects incoming network traffic either to the outside world via interface 555 or towards the http server 565 via path 545. For example if a browser based application authored in XHTML and running a local scripting language (in the browser) such as JavaScript or VBScript requests a new resource, whether it is a new page or an XMLHttpRequest type data call, this request will be brokered from the browser through the proxy to the http server for handling. If the request is for a web page or similar addressable asset, the http server 565 can then pull the resource and serve it back to the browser. The http server can fetch the resource from one of several local objects which are part of the present invention. These include a locally mounted file system (as implied by http server), or the local app bundle manager 535 which is connected to the http server via path 540. If the request is a data call or a callback function to a server side scripting language such as PHP, Python, Java Enterprise Edition, servlets or Common Gateway Interface Scripts, such are known in the art, the server will hand the request off to a processing engine. In the case of a server side scripting language such as those just mentioned, the request is handed via path 570 to processing engine 575 which handles the request, provides language specific features, and maintains session management information or server side variables. If the request is via web description language interface such as SOAP, WSDL, REST, XML remote procedure call, or similar function then it can be handed off via path 585 to a specialized engine 523 which functions as previously mentioned to complete the request functionality. It is also possible to use the server side scripting engine to complete the call via path 590 to specialized services such as 523 thereby enabling either AJAX only applications (e.g. those which only have browser based code and logic) or server based code and logic to share SOAP/REST/Web services plug-ins. The present invention also can provide access to a local SQL database as shown in box 513. This is connected to the web services manager 523 via path 517. The database provides the ability to store end user data such as preferences, location, or profile information. Applications running in the browser can access the SQL database via server side scripts running in box 575 or via a direct web services software call (SOAP call) which is issued through the web services manager directly. The database also connects to a data synchronization engine 525 via path 503. More detail on the operation of the synchronization engine will be discussed in a subsequent paragraph. Application resources are stored in the database marked App Bundles 535. This is connected via path 540 to the http server directly. The App Bundles database is also connected to sync engine 525 via path 530.

The app bundle manager, box 535 manages entire web application assets such as those depicted in box 310 of FIG. 3. When a request is made to a particular file which may be stored as a part of an atomic bundle which comprises the application assets, the proxy 580, http server 555, and app bundle manager 535 work in succession to resolve the file just as if it had been hosted on an internet server. Note that these components also work to resolve same origin policy security enforcement in much the same way that a browser cache does—in other words xyz.foo.com/mypage.xhtml can be stored locally but accessed in a programmatic way rather than as the browser cache which acts in an automatic (non programmatically controlled) method. Universal Resource Locators (URLs) which explicitly resolve to local addresses (such as ports running on 127.0.0.1, the http loopback address) resolve and are served to the local browser 505 via http interface 510. The browser may not be explicitly aware of the location which actually serves the file.

An additional functionality of the present invention is the use of the sync engine, box 525 to update the locally stored applications (box 535) and locally stored SQL database 513 via paths 530 and 513 respectively. This allows applications stored as bundles to be atomically stored on the mobile device as a single file. The sync engine can then manage the storage, updating, upgrading, and subscription status of several such applications. For example a server could store information about a subscription application which the local sync engine would enforce. When the subscription expires the application bundle would be disabled or deleted. This functionality extends the type of application storage once associated with dedicated runtimes such as Java Micro Edition to web based applications. In addition the sync engine can store, synchronize and manage application data stored in the SQL database. In a typical (server based) application user data, such as shopping cart information on an ecommerce based web store or photographs on a photo sharing website would be stored on that site's database. In the present invention the ability to utilized web based protocols to store application data locally is now available though web services calls. More over the synchronization engine can then move user data stored in the local database back to a classically running server at an internet URL. The synchronization engine in the present invention therefore allows both applications and user data to be stored on a local device and then, should that device be lost or the user acquire a newer, perhaps upgraded device, the user's applications and the application's data can be seamlessly re-provisioned to the new device. The sync engine also can access the external internet through proxy 560 by using path 520. This allows the sync engine to move code assets and user and application data stored in the either the App Bundles database 535 or App Data database 513 and maintain them in accordance with business rules for subscription or provisioning of the user's applications. The present invention, since it uses databases to store application bundles and user data, can also support different application permissions for different users allowing some to have access to more or different data than others.

FIG. 6. depicts the present invention, labeled 610 serving multiple web applications to a local web browser 600 simultaneously via http as shown in path 605. Here applications are stored locally on device file system as shown by box 635 and connected via path 640 which represents the local file system. Alternative applications can be stored as application bundles as shown by boxes 615, 625, and 630 (note collectively this is also depicted as box 535 in FIG. 5). These bundled applications are stored locally and hence path 620 represents the internal connections the app bundle storage mechanism. Since each application effectively represents an entire website co-hosted on the same server, to the user these applications appear to run simultaneously. The present invention allows both app bundles and file system based applications to be mounted and served at the same time.

FIG. 7. Depicts how the present invention can extend web services call to the application programming interfaces (API) of the local environment. Usually browsers would sandbox or prevent a web application from having access to the local system. This happens in two ways. The first is there are no direct programming interfaces (APIs) to access local resources or the file system through JavaScript, or the XHTML DOM structures. Secondarily sandboxing is used for security reasons to prevent malicious web programs from affecting local files. The present invention provides an entire server side stack with web services extensions via SOAP, XML RPC, REST or the like to access device local resources thereby preserving the security model yet allowing the web programming model access to these services. An application running in the browser 600 is connected via path 605 to 610 in FIG. 6 and FIG. 7. Then local services are access via path 553 to box 700 which depicts a plug-in service which the device wishes to expose to the web programming environment. Box 700 is an extension API which permits local services to expose functionality to the present invention.

FIG. 8. Depicts provisioning of applications or user data over the internet. Note that in this Figure, some of the labels are the same as earlier figures as these are the same parts and hence consistency is maintained. Box 500 depicts the computer or mobile device in which the present invention is executing. The browser 600 is connected to the present invention 610 via path 605 which represents an http connection. The present invention is then connected via path 555 internally to the device, which is equivalent to path 105 externally to the device, via the internet 110, to path 805, to a synchronization server 800. The synchronization server contains two logical components in addition to network infrastructure (http server, firewall, load balancer) which is implemented as part of a standard configuration known to those skilled in the art. These two extra logical components are the Application Bundles database shown by 820 and the User Data database shown by 825. The application bundles represent stored applications which can be either served directly by the sync server in much the same way the present invention runs as depicted in FIG. 2 to FIG. 7 except that the server is running on the internet instead of on the local computer or handheld device. The applications bundles database primary service is to provision applications stored on the sync server and copy them to the WebVM installation on the client computer or mobile device. In other words the internet hosted sync server acts as a remote data-store for applications, and as a means for providing new applications which can be downloaded and stored locally by the present invention. An example of this type of functionality in action is the purchasing of a new application on an online web store. Then the sync server will push the application bundle down to the present invention for storage and installation. The present invention will then store the application locally much like a Java language or BREW language application would be stored. The sync server also provides the ability for subscription based applications which are locally stored depending on the metadata which determines the application's lifetime. For example the user could purchase an application for 1 month after which the present invention, WebVM, would delete that from device local storage. However the sync server could still maintain a copy so that an individual user could purchase a new subscription and to serve as a store for new users to purchase applications. Another purpose of the application bundle database on the sync server is to provide back up services for applications. For example if a device is lost or stolen the user can acquire a new device. At this point the sync server could, in conjunction with the present invention, send all of the user's old applications, since they are stored at the sync server, to the new device at which time the present invention would restore the applications that were lost on the lost or stolen device. The second piece of storage on the sync server is the user data SQL database. Unlike application bundles which are generic to an application and contain programmatic resources such as XHTML files, and the like the user data database stored personal settings such as preferences for each of the user's applications, documents—for example word processing files or game levels, and user device and subscription information. The portion of 825 which stores the user's documents and local data can be a mirror copy of that stored in the WebVM App Data database depicted as box 513 in FIG. 5. Should a user's device be lost or stolen and the user must get a new device, the present invention allows the re-provisioning of the user's new device to restore it to the same activity levels as the user's old device. The User Data database 825 allows the re-provision of user state data to their new device. In this way not only are applications reinstalled by the sync server to the new device, but the user's documents and settings are likewise also restored. Note that it is possible, depending on synchronization rules to also de-provision a device—in other words to turn off remotely a set if applications and erase the data should the system be so enabled. This allows the system to effectively remove old devices or stolen or lost devices from the overall service in a graceful way and to minimize the compromising of sensitive data that could have been stored on the old device.

What is claimed is:

1. A system for running web based applications transparently online or offline consisting of an http server, a network proxy, an application bundle management database, a conventional database, and a web services bridge for local services where said system runs locally on a computing device.

2. A system as in claim 1 which allows web applications to be synchronized over the internet as a single file.

3. A system as in claim 2 in which a manifest file allows for the describing the contents of the web application file for signing purposes and execution permission purposes.

4. A system as in claim 1 where multiple web applications may be running simultaneously and each with a different level of security permissions.

5. A system as in claim 1 where data from multiple different servers can be aggregated to form a single data view without need for an off device server.

6. A system as in claim 1 where said computing device is a cellular telephone.

7. A system as in claim 1 where said computing device is an embedded computer system.

8. A system as in claim 1 where said computing device is a personal computer.

9. A system as in claim 1 for allowing subscription applications to run on said local computing device which may expire and be deleted.

10. A system as in claim 1 where user data may be synchronized with a server of the internet and stored as records in a SQL database.

11. A System as in claim 1, in which multiple applications are served simultaneously on separate IP addresses.

12. A System as in claim 11 in which said applications have different access rights to local resources.

13. A System as in claim 1, in which multiple applications are served simultaneously on separate IP address and port combinations.

14. A System as in claim 13 in which said applications have different access rights to local resources.

15. A system as in claim 1 in which local APIs can be accessed through SOAP, RPC, WSDL, XMLHttpRequest or web services language calls.

16. A System as in claim 1 in which different users can have different access privileges can be enforced for both applications and data access.

17. A System as in claim 1 in which digital certificates can be used to sign web applications which run on a local device as part of a bundle.
